(19) United States
(12) Patent Application Publication
(10) Pub. No.: US 2003/0129106 A1
(43) Pub. Date: Jul. 10, 2003

(54) Semiconductor processing using an efficiently coupled gas source

(75) Inventors: Carl A. Sorensen, Morgan Hill, CA (US); Albert R. Ellingboe, Malahide (IE); Quanyuan Shang, Saratoga, CA (US); Wendell T. Blonigan, Union City, CA (US); John M. White, Hayward, CA (US)

Correspondence Address: PATENT COUNSEL, APPLIED MATERIALS, INC., Legal Affairs Department, P.O. Box 450A, Santa Clara, CA, 95052, US

(73) Assignee: APPLIED MATERIALS, INC.

(21) Appl. No.: 10/231,867

(22) Filed: Aug. 29, 2002

Related U.S. Application Data
(60) Provisional application No. 60/316,380, filed on Aug. 29, 2001.

(51) Int. Cl. B01J 19/08

(52) U.S. Cl. 422/186.05; 422/186.06

(57) ABSTRACT

A semiconductor processing system includes a processing chamber system and an activated gas source coupled to the chamber system. The gas source includes a primary winding coupled to an RF generator and a secondary winding effectively formed by the conductance of a plasma filled passageway in a toroidal chamber. The primary winding and the secondary winding are coaxially aligned to provide a suitable inductive coupling between the windings.

### CROSS REFERENCE TO RELATED APPLICATIONS

This application claims priority benefit under 35 U.S.C. § 119(e) from provisional application No. 60/316,380, filed Aug. 29, 2001. The 60/316,380 application is incorporated by reference herein, in its entirety, for all purposes.

### INTRODUCTION

The present invention relates generally to the field of semiconductor processing systems. More particularly, the present invention relates to semiconductor processing systems utilizing activated gas sources.

### BACKGROUND INFORMATION

Sophisticated electronic devices have become key enabling technology in recent years. Consumer electronics of increasing complexity, competence, and reliability provide for the dissemination of news and entertainment content. The rise of automation in the industrialized world has fueled a quiet revolution of increased worker efficiency. The advances in telecommunications, particularly wireless telecommunications, have been astonishing over the last thirty years.

Underlying all of these powerful enabling technologies are semiconductor devices that each has millions of transistors that were manufactured together, simultaneously as a single, integrated product. Examples are microprocessor “chips” and flat panel displays. The industry that mass produces these semiconductor marvels uses machines that place flat work pieces called substrates into vacuum chambers that alternately put stuff on (e.g., deposition), take stuff off (e.g., etch), smooth (e.g., chemical mechanical polishing), or perform other operations on the substrate, such as testing or imaging. These machines that are used to make the semiconductor marvels are themselves pretty marvelous.

Plasma assisted chemical reactions have been widely used in the semiconductor and flat panel display industries. A plasma is formed by exciting a mix of gasses so as to strip away many of the electrons from the gas molecules and even dissociate many of the molecules themselves into smaller constituent molecules.

One example of such a process is plasma-enhanced chemical vapor deposition (PECVD), which is a process that is used in the manufacture of thin film transistors (TFT) for active-matrix liquid crystal displays (AMLCDs). In accordance with PECVD, a substrate is placed in a vacuum deposition chamber that is equipped with a pair of parallel plate electrodes. One of the electrodes holds the substrate, and is commonly referred to as a susceptor or lower electrode. The other electrode (often located above the susceptor and referred to as the upper electrode) functions as a gas inlet manifold or showerhead. During deposition, a reactant gas flows into the chamber through the upper electrode and a radio frequency (RF) voltage is applied between the electrodes to produce a plasma within the reactant gas. The plasma causes the reactant gas to decompose and deposit a layer of material onto the surface of the substrate.

Though such systems are designed to preferentially deposit the material onto the surface of the substrate, they also deposit some material onto other interior surfaces within the chamber. Consequently, after repeated use, these systems are typically cleaned to remove the deposited layer of material that has built up in the chamber. To clean the chamber and the exposed components within the chamber, an in situ dry cleaning process is commonly used. According to the in situ technique, precursor gases are supplied to the chamber. Then, by locally applying a glow discharge plasma to the precursor gases within the chamber, reactive species are generated. The reactive species clean the chamber surfaces by forming volatile compounds with the process deposit on those surfaces.

This in situ cleaning technique has several disadvantages. First, it is often inefficient to use a plasma within the chamber to generate the reactive species. Thus, it may be necessary to use relatively high powers to achieve an acceptable cleaning rate. The high power levels, however, tend to cause damage to the hardware inside of the chamber thereby significantly shortening its useful life. Since the replacement of the damaged hardware can be quite costly, this can significantly increase the per-substrate cost of product that is processed using the deposition system.

Another problem with the conventional in situ dry cleaning processes is that the high power levels required to achieve acceptable cleaning rates also tend to generate residues or byproducts that can damage other system components. In addition, these residues may require physically wiping off the internal surfaces of the chamber to remove them. As an example, in a deposition system in which the chamber or the process kit components (e.g. heater, shower head, clamping rings, etc.) are made of aluminum, an NF₃ plasma is often used to clean the interior surfaces. During the cleaning process, a certain amount of Alₓ F_{y} molecules are often formed. The amount that is formed can be greatly increased by the ion bombardment that results from the high plasma energy levels. Thus, a considerable amount of Alₓ F_{y} can be formed in the system. Unfortunately, this material often is not readily etched away by a chemical process, and therefore must more typically removed by physically wiping the surfaces.

One solution is to excite the plasma in a remote chamber. In this method, a remote excitation source is used outside of the process chamber to generate a reactive species. This species is supplied to the process chamber to assist in carrying out a particular process, for example, dry cleaning the chamber.

However, some remote excitation chambers may utilize a carrier gas such as argon mixed with the precursor gas to assist in initiation or maintenance of the plasma. Such carrier gasses may be incompatible with some processing chambers and therefore function as a contaminant to the chamber that is to be cleaned.

Thus, what is needed is a dry cleaning process that will thoroughly clean the interior surfaces of a chamber without leaving behind undesirable residues or contaminants.

### SUMMARY OF THE INVENTION

In one aspect of the illustrated embodiments, a gas source for use with a semiconductor processing chamber is provided comprising a primary winding having at least one turn surrounding a central axis, and a toroidal shaped plasma generation chamber having a passageway surrounding the same central axis. A plasma generated in the passageway of the toroidal chamber functions as a secondary winding within the chamber and surrounding the central axis. As a consequence, the secondary winding is efficiently coupled to the primary winding to activate a gas flowing through the chamber.

There are additional aspects to the present inventions as discussed below. It should therefore be understood that the preceding is merely a brief summary of some embodiments and aspects of the present inventions. Additional embodiments and aspects of the present inventions are referenced below. It should further be understood that numerous changes to the disclosed embodiments could be made without departing from the scope of the inventions. The preceding summary therefore is not meant to limit the scope of the inventions. Rather, the scope of the inventions is to be determined only by the appended claims and their equivalents.

Additional objects and advantages of the present invention will be apparent in the following detailed description read in conjunction with the accompanying drawing figures.

### BRIEF DESCRIPTION OF THE DRAWINGS

FIG. 1 illustrates a schematic view of a semiconductor processing system in accordance with one embodiment of the present inventions.

FIG. 2 illustrates a perspective view of one embodiment of the plasma source for the processing system shown in FIG. 1.

FIG. 3 illustrates a cross-sectional view of the plasma source shown in FIG. 2, taken along section line III-III.

FIG. 4 illustrates a cross-sectional view of the plasma source shown in FIG. 2, taken along section line IV-IV.

FIG. 5 illustrates a schematic view of system geometry according to one embodiment of the plasma source.

FIG. 6 illustrates a schematic view of an alternative embodiment of the plasma source.

FIG. 7 illustrates a schematic view of another alternative embodiment of the plasma source.

FIG. 8 illustrates an elevation view of yet another alternative embodiment of the plasma source.

FIG. 9 illustrates a plan view of a further alternative embodiment of the plasma source for the processing system shown in FIG. 1.

FIG. 10 illustrates a cross-sectional detail view of the plasma source of FIG. 9, taken along section line X-X.

### DETAILED DESCRIPTION OF THE EMBODIMENTS

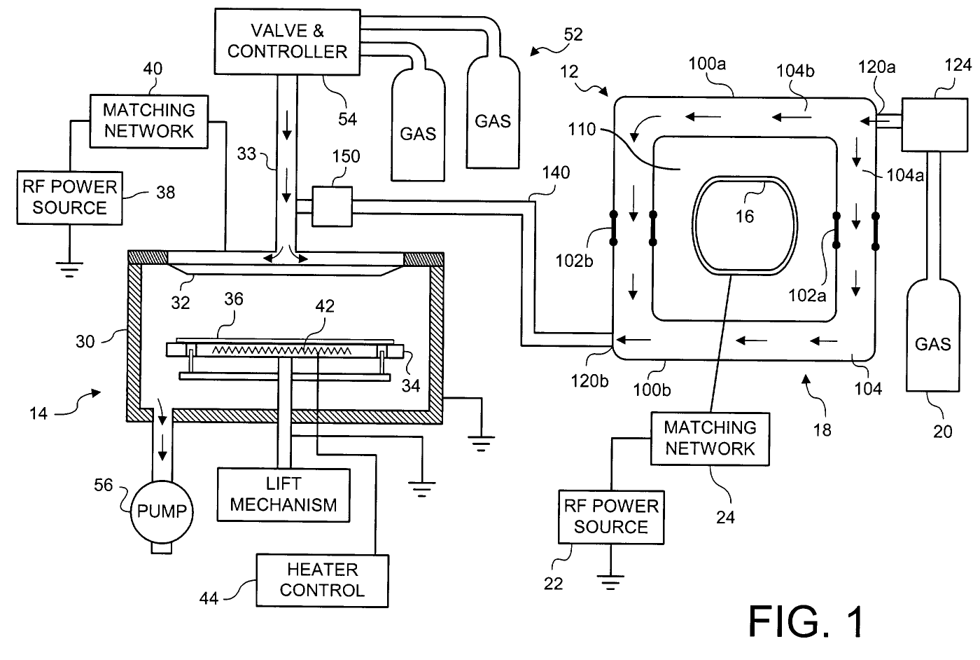

Referring to FIG. 1, a semiconductor processing system 10 in accordance with one embodiment of the present invention is illustrated. The processing system 10 includes a plasma source 12 coupled to a process chamber system 14. The chamber system 14 may be advantageously embodied using is a model AKT-1600 PECVD System, available from Applied Komatsu Technology, with modifications as described herein. The AKT-1600 PECVD is intended for use in the production of active-matrix liquid crystal displays (AMLCDs). It is a modular system with multiple process chambers that are useful for depositing amorphous silicon, silicon nitride, silicon oxide and oxynitride films. This particular chamber system is discussed simply as an example, as the invention may be advantageously practice using any commercially available deposition or etching system.

As explained in greater detail below, and in accordance with one aspect of the present inventions, the plasma source 12 includes a primary winding 16 coaxially aligned with and inductively coupled to a toroidal vessel 18. A flow of gas from a source 20 through the vessel 18 is ionized by RF energy coupled from the primary winding 16. An RF generator 22 drives the primary winding 16, and is coupled to the primary winding 16 via a matching network 24. When ionized, the gas flowing through the toroidal vessel 18 forms a plasma that acts as a secondary winding coaxially aligned with the primary winding 16. The plasma flow from the plasma source 12 may be utilized by the process chamber system 14 for a variety of functions including cleaning. Such cleaning removes deposited material from the interior surfaces of a deposition chamber 30 of the process chamber system 14.

The deposition chamber 30 has a gas inlet manifold (or shower head) 32 for introducing deposition gases and a susceptor 34 for holding a substrate 36 onto which material is to be deposited. The gas inlet manifold 32 and the susceptor 34, which are both in the form of parallel plates, also function as upper and lower electrodes, respectively. The susceptor 34 (or lower electrode) and the chamber body are connected to ground. An RF generator 38 supplies RF power to the gas inlet manifold 32 (or upper electrode) through a matching network 40. The RF generator 38 is used to generate a plasma between the upper and lower electrodes 32, 34.

The susceptor 34 includes a resistive heater 42 for heating the substrate 36 during deposition. An external heater control module 44 powers the heater 42 to achieve and maintain the susceptor 34 at an appropriate temperature level as dictated by the process being run in the system.

A gas supply 52, disposed outside of the chamber 30, contains process gases that are used during deposition. The particular process gases that are used depend upon the materials are to be deposited onto the substrate 36. The process gases flow through an inlet pipe 33 into the gas inlet manifold 34. The process gases flow then flow into the chamber 30 through the gas inlet manifold (or showerhead) 34. An electronically operated valve and flow control mechanism 54 controls the flow of gases from the gas supply 52 into the chamber 30. Also connected to the chamber 30 through an outlet port is a vacuum pump 56, which is used to evacuate the chamber and maintain a suitable vacuum pressure inside the chamber 30.

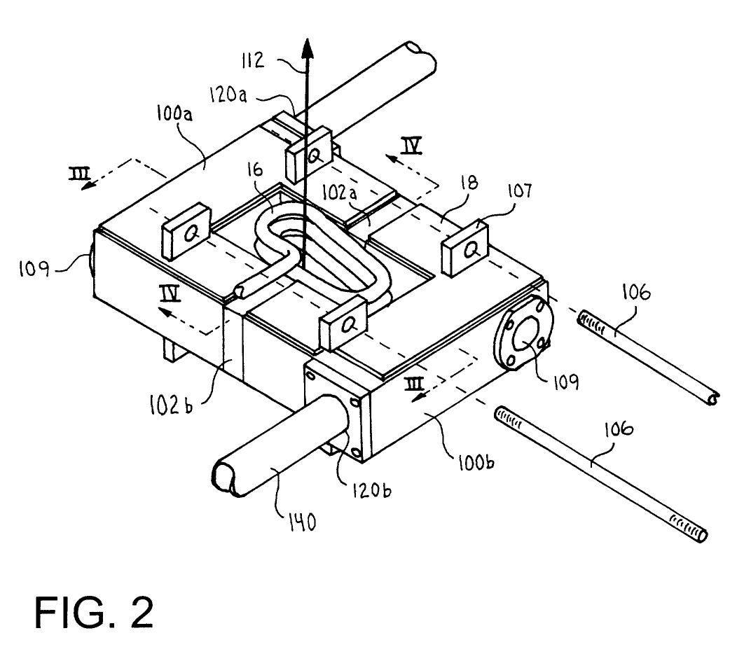

Referring to FIG. 2, a perspective view of one embodiment of the plasma source for the processing system is illustrated. The toroidal vessel 18 according to this embodiment includes a pair of semi-vessels 100a, 100b that are separated from one another by a pair of dielectric spacers 102a, 102b. Each semi-vessel has an optional view port 109.

Each of the semi-vessels 100a, 100b is a generally U-shaped hollow conduit made from a material that is preferably electrically conductive, is resistant to plasma and reactive ions, and is a good heat conductor. One example of a suitable conduit material is a coated metal such as anodized aluminum. Other conductive and nonconductive materials such as copper and quartz are also suitable, depending upon the particular application.

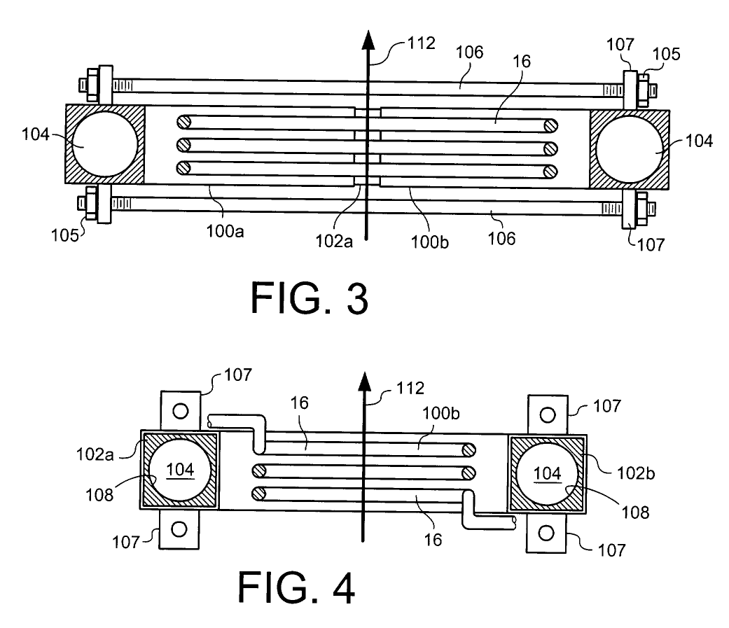

Referring to FIG. 3, a cross-sectional view of the plasma source shown in FIG. 2, taken along section line III-III, is illustrated. As seen in the cross-sectional view of FIG. 3, each semi-vessel 100a, 100b defines an interior passageway 104 that runs the length of each semi-vessel 100a, 100b. In the illustrated embodiment, the passageway has an interior diameter of ¾ inch (18 mm). Other sizes would be useful, depending upon the application.

Referring to FIG. 4, a cross-sectional view of the plasma source shown in FIG. 2, taken along section line IV-IV, is illustrated. As seen in the cross-sectional view of FIG. 4, each dielectric spacer 102a, 102b also has an interior aperture 108 that forms part of the passageway 104. When the semi-vessels 100a, 100b are assembled with the dielectric spacers 102a, 102b non-conductively spacing the semi-vessels 100a, 100b from each other, the passageway 104 forms a complete circuit as schematically represented in FIG. 1. In the illustrated embodiment, the complete circuit has a perimeter of approximately 20 inches (51 cm). Other lengths would be useful as well, the length of the illustrated embodiment showing an example only and not being a limitation to the scope of the present invention.

Once the gas flowing through the passageway 104 has ionized to form a plasma, the plasma-filled passageway 104 functions effectively as a single turn secondary winding. The semi-vessels 100a, 100b are assembled with the spacers 102a, 102b to form a pressure tight vessel using, for example, threaded rods 106 which pass through flanges 107 attached to the semi-vessels 100a, 100b. A pressure-tight seal between the spacers 102a, 102b and semi-vessels 100a, 100b is effected using vacuum seals positioned between the spacers and semi-vessels, which are sealed by tightening nuts 105 threaded onto the rods 106. Other suitable fastening apparatus may be used in the alternative.

The toroidal vessel 18 has a hollow rectangular central portion 110 (FIG. 2) that defines a center axis 112. The central portion 110 forms a core about which the secondary winding provided by the plasma-filled passageway 104 is in effect wound. The primary winding 16 is disposed in the central portion 110. In the illustrated embodiment, the primary winding 16 has four turns and is formed from a hollow conduit such as insulated copper tubing. The number of turns may vary, depending upon the application. In general, the greater the number of turns, the greater the impedance and the lower the current levels. However, the optimal impedance of the primary coil 16 may depend upon the loop impedance of the secondary winding, which may depend upon the particular gas or gas mixture being activated. Water or other coolant may be caused to flow through the interior of the tubing of the primary winding 16 for cooling purposes. The toroidal vessel 18 may also be optionally provided with coolant carrying channels (not shown).

The turns of the primary winding 16, like the single turn of the secondary winding of passageway 104, are centered on central axis 112. In addition, the primary winding is disposed entirely within the air core of the secondary winding. Hence, the cores of the primary winding 16 and the secondary winding share the same core (that is, the air core of the primary winding 16) and are efficiently inductively coupled. According to the illustrated embodiment, it is believed that the inductive coupling exceeds 90% in some applications, depending upon gas type and pressure. Although the primary and secondary windings are illustrated as sharing an air core, other cores such as a ferrite core may be used as well to enhance coupling.

One of the semi-vessels 100a has an inlet 120a through which a flow of precursor gas is admitted into the vessel passageway 104 by a valve and flow control mechanism 124 (refer to FIG. 1) which delivers gas from the source of precursor gas 20 into the toroidal vessel 18 at a user-selected flow rate. According to an exemplary embodiment, the precursor gas is NF₃ and a flow rate is selected in the range of 0.5 to 8 liters per minute. The RF generator 22 applies a high frequency current, preferably an RF current, through the matching network 24 to the primary coil 16. In this exemplary embodiment, the RF generator provides an RF signal at 13.56 MHz. For some applications, this frequency may be varied between 12.5 and 14.5 MHz to achieve proper match. Other frequencies, RF and non-RF, may also be used, depending upon the particular application.

The RF current passing through the primary coil 16 creates an axial magnetic field aligned with center axis 112. This alternating magnetic field induces an alternating voltage around the loop formed by the vessel 18. Initially, before a plasma has been formed, most of the induced loop voltage is forced to appear across the two dielectric spacers 102a, 102b. This induced voltage in turn causes an electrostatic discharge to ionize precursor gas and thus initiate ignition of a plasma. During an initial start-up stage, it is preferred that the power level of the RF generator 22 be initially set relatively low, for example, in the range of 3 to 400 watts. After a plasma has been established, the power may then be ramped up to a larger, operational level, for example, about 1000 watts. The power levels will necessarily vary, depending the particular application.

As the start-up stage progresses, the conductive plasma spreads through the passageway 104, starting at the two dielectric spacers 102a, 102b until the plasma fills the entire passageway 104 of the toroidal vessel 18. Once the circuit is completed, the plasma-filled passageway 104 forms a low impedance, single turn winding that functions as a secondary winding inductively coupled to the primary winding 16. In this manner, RF energy from the RF generator 22 is efficiently coupled into the interior of the toroidal vessel 18 to ionize and activate the precursor gas. The dielectric spacers 102a, 102b reduce or eliminate eddy currents in the toroidal vessel. In addition, the conductive semi-vessels 100a, 100b shield the plasma from the relatively high voltage present on the primary coil 16. As a consequence, sputtering of the interior passageway 104 may be reduced or eliminated.

As illustrated in FIG. 1, the precursor gas flowing from the inlet 120a splits and flows in the two legs 104a and 104b of the passageway 104 to an outlet 120b of the toroidal vessel 18. During this flow through the vessel 18, the precursor gas is ionized and activated by the plasma. The flow of activated gas flows from the outlet 120b through a pipe 140 to the inlet 33 of the processing chamber system 14.

Optionally, there may also be a source of a minor carrier gas that is connected to the inlet 120a of the vessel 18 through another valve and flow control mechanism. A minor carrier gas may in some applications aid in the transport of the activated species to the deposition chamber. This minor carrier gas is selected to be any appropriate non-reactive gas that is compatible with the particular cleaning process in which it is being used. For example, the minor carrier gas may be argon, nitrogen, helium, hydrogen, oxygen, or the like. In addition to aiding in the transport of activated species to the deposition chamber, the carrier gas may also assist in the cleaning process or help initiate and/or stabilize the plasma in the deposition chamber.

However, in many applications, use of a carrier gas mixed with the precursor gas may be undesirable. This would be particularly true in semiconductor processing chambers that do not use the carrier gas for the substrate processing. For example, argon may be incompatible with many processing chambers. In accordance with one aspect of the present invention, because of the efficient coupling between the primary coil 16 and the secondary winding of the toroidal vessel 18 of the illustrated embodiment, the use of such carrier gasses to help initiate or stabilize the plasma can be reduced or eliminated. Thus, an argon-free flow of activated NF₃ may be provided by the plasma source 12 during both startup and operation.

For efficient operation, the internal pressure of the toroidal vessel 18 is held at a pressure suitable for the particular application. Typical pressures are in the range of 0.1 to 20 Torr. In some applications it may be desirable to maintain the pressure as high as feasible. In other words, the pressure differential between the vessel 18 and the deposition chamber may be made as large as possible and may be at least, for example, 4.5 Torr. The pressure in the toroidal vessel 18 may be higher, for example, in the range of about 5 Torr to about 20 Torr, and in particular may be about 15 Torr. The pressure in the deposition chamber may be, for example, in the range of about 0.1 Torr to about 2 Torr, and in particular about 0.5 Torr. A flow restrictor 150 is employed to allow a high pressure plasma to be maintained without detrimentally affecting the pressure of deposition chamber 30. The flow restrictor 150 may be, for example, a small orifice or a series of small orifices, although any device that creates a pressure differential, such as a reduction valve or a needle valve, could be employed. The flow restrictor 150 may be placed at or near the point at which the pipe 140 enters deposition chamber 30.

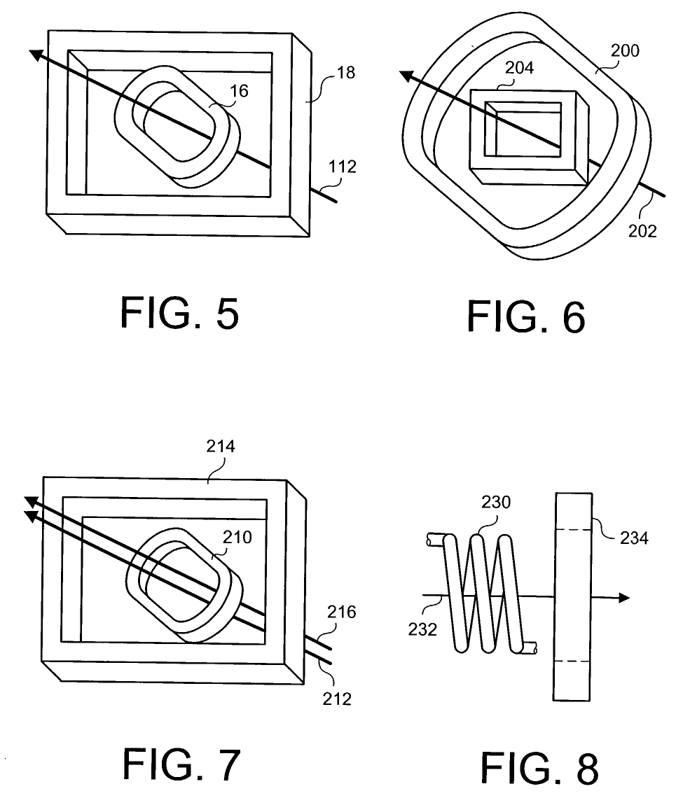

Referring to FIG. 5, the co-axial spatial relationship between the primary windings 16 and the secondary winding of the toroidal vessel 18 are represented schematically. As shown therein, the primary windings 16 define the same center axis 112 as the secondary winding of the toroidal vessel 18. In addition, the secondary winding of the toroidal vessel 18 surrounds the complete (i.e., full) circumference or perimeter, of the primary windings 16.

Referring to FIG. 6, a schematic view of geometry according to an alternative embodiment is illustrated, in which a primary winding 200 defines the same center axis 202 as the secondary winding of a toroidal vessel 204 except that the primary windings 200 surround the complete turn or full circumference of the secondary winding of the toroidal vessel 204. Such a co-axial arrangement is also believed to provide improved coupling between the primary coil and the secondary winding of a plasma source. In the embodiments illustrated by FIGS. 5 and 6, the primary and secondary windings are coaxially aligned without substantial axial displacement.

Referring to FIG. 7, a schematic view of geometry according to another alternative embodiment is illustrated, in which a primary winding 210 defines a center axis 212 and a secondary winding of a toroidal vessel 214 defines a center axis 216 that is not coaxial with the center axis 212. However, both center axes 212, 216 are surrounded by both the primary winding 210 and the secondary winding of the toroidal vessel 214. Although the center axes 212, 216 are depicted as parallel, it is believed that good coupling may be maintained even if the center axes 212, 216 are somewhat askew relative to each other. However, it is believed that efficiency is well maintained when both the primary winding and the secondary winding of the toroidal vessel surround the center axis of the other.

Referring to FIG. 8, an elevation view of geometry according to yet another alternate embodiment is illustrated, in which a primary coil 230 is axially displaced along a defined center axis 232, relative to the secondary winding of a toroidal vessel 234. Although the primary coil 230 is depicted as being coaxial with the secondary winding, it is believed that good coupling may be maintained even if the center axes of the primary winding 230 and the secondary winding are different and somewhat askew, as explained above.

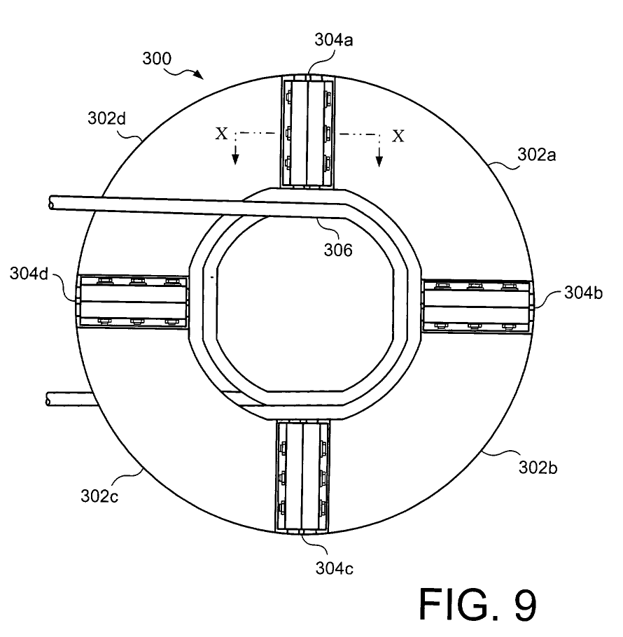

Referring to FIG. 9, a further alternative embodiment is illustrated, in which the toroidal vessel 300 is substantially round in shape rather than the substantially rectangular shape of the embodiment of FIG. 1. In addition, the vessel 300 includes four quarter-vessels 302a, 302b, 302c, 302d spaced apart from one another by four dielectric spacers 304a, 304b, 304c, 304d equally spaced around the perimeter of the vessel 300. A primary coil 306 is formed from several turns of insulated clad copper tubing wound in a quasi-octagon shape. The primary coil 306 is disposed in the air core 308 defined by the hollow center of the toroidal vessel 300.

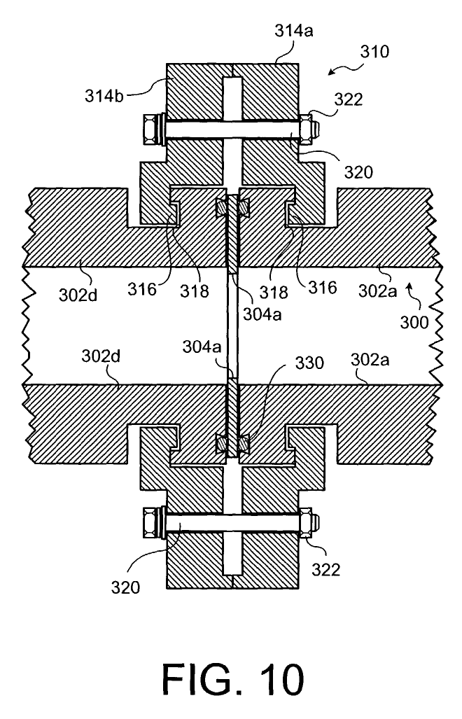

Referring to FIG. 10, a cross-sectional detail view of the plasma source of FIG. 9, taken along section line X-X is illustrated. Each of the dielectric spacers, such as the spacer 304a, is clamped between two adjacent quarter-vessels 302a, 302d, by a clamp assembly 310, which includes a pair of dielectric clamp arms 314a, 314b. Each clamp arm has a finger portion 316 that is received in a correspondingly shaped recess 318 in the associated quarter-vessel. A threaded bolt 320 is passed through the assembled clamp arms 314a, 314b. As a nut 322 is tightened, the clamp arms 314a, 314b draw the quarter-vessels together, clamping the dielectric spacer 304a between. To ensure a pressure-tight seal, vacuum seals 330 may be provided between the spacers and the quarter-vessels.

In the illustrated embodiments, the primary coils are formed from insulated copper tubing having an outer diameter of one-quarter inch (6 mm). Other conductive materials and sizes may be used as well.

In general, the precursor gasses for producing the reactive species are selected from a wide range of options, including the commonly used halogens and halogen compounds. Examples of such reactive gases are chlorine, fluorine, and compounds thereof (e.g., NF₃, CF₄, SF₆, C₂F₆, CCl₄, C₂Cl₆). Of course, the particular gas that is used depends on the deposited material that is being removed in a cleaning application. For example, in a tungsten deposition system a fluorine compound gas is typically used to etch away tungsten deposited on the walls of the system to effect cleaning of those walls.

It will be understood by those having ordinary skill in the art that the frequencies, power levels, flow rates, and pressures that are chosen are system specific and thus they will need to be optimized for the particular system in which the process is being run. Making the appropriate adjustments in process conditions to achieve optimum performance for a particular system is well within the capabilities of a person of ordinary skill in the art.

Although the invention has been explained and illustrated in terms of embodiments that involved a PECVD system, the invention has far wider applicability. For example, the concept of a remote activation source (i.e., outside the main vacuum chamber), possibly used in conjunction with a local activation source (i.e., inside the main vacuum chamber) is useful in systems designed for the purposes of physical vapor deposition (PVD), chemical vapor deposition (CVD), ion doping, stripping of photoresist, substrate cleaning, plasma etching, and other purposes as well.

It will, of course, be understood that modifications of the present invention, in its various aspects, will be apparent to those skilled in the art, some being apparent only after study, others being matters of routine electrical and mechanical design. Other embodiments are also possible, their specific designs depending upon the particular application. As such, the scope of the invention is not be limited by the particular embodiments herein described but should be defined only by the appended claims and equivalents thereof.

What is claimed is:

1. A gas source for use with a semiconductor processing chamber, comprising:
a primary winding having at least one turn surrounding a central axis; and
a toroidal shaped plasma generation chamber, the chamber comprising:
a passageway surrounding the central axis,
a gas inlet fluidly coupled to the passageway, and
a gas outlet fluidly coupled to the passageway;
wherein a plasma generated in said passageway of the toroidal shaped plasma chamber functions as a secondary winding within the chamber and surrounding said central axis, the secondary winding being inductively coupled to the primary winding.

2. The gas source of claim 1, wherein the toroidal shaped plasma generation chamber has a wall formed of a conductive material.

3. The gas source of claim 2, wherein the conductive wall includes first and second wall portions, the toroidal shaped plasma generation chamber having a dielectric spacer disposed between the first and second wall portions and electrically isolating the first and second wall portions from one another.

4. The gas source of claim 1, wherein the toroidal shaped plasma generation chamber defines an aperture through which the central axis passes, and wherein the primary winding has at least one turn disposed within the aperture so that the chamber completely surrounds the at least one turn of the primary winding.

5. The gas source of claim 1, wherein the primary winding defines an aperture through which the central axis passes, and wherein the toroidal shaped plasma generation chamber is disposed within the aperture so that primary winding completely surrounds the toroidal shaped plasma generation chamber.

6. The gas source of claim 1, wherein the primary winding and the toroidal shaped plasma generation chamber passageway are coaxially aligned along the central axis.
